(19) United States
(12) Patent Application Publication
(10) Pub. No.: US 2008/0136761 A1
(43) Pub. Date: Jun. 12, 2008

(54) Display Apparatus and Method of Driving the Same

(75) Inventors: Sung-Jin Hong, Seoul (KR); Cheol-Woo Park, Suwon-si (KR); Il-Pyung Lee, Suwon-si (KR); Young-Chol Yang, Seongnam-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/927,422

(22) Filed: Oct. 29, 2007

(30) Foreign Application Priority Data
Dec. 12, 2006 (KR) 2006-126456

(51) Int. Cl. G09G 3/36

(52) U.S. Cl. 345/89

(57) ABSTRACT

In a display apparatus, a data driver converts a first group of image data into a first data voltage based on a first gamma reference voltage during a first period and converts a second group of the image data into a second data voltage based on a second gamma reference voltage during the first period. The data driver converts the first group into the second image voltage during a second period and converts the second group into the first data voltage during the second period. First and second pixel groups receive the first and second data voltages to display first and second gray-scale images, respectively, during the first period, and receive the second and first data voltages to display the second and first gray-scale images, respectively, during the second period. Thus, display quality and viewing angle characteristic of the display apparatus are improved and flicker is prevented.

### CROSS-REFERENCE TO RELATED APPLICATION

This application relies for priority upon Korean Patent Application No. 2006-126456 filed on Dec. 12, 2006, the contents of which are herein incorporated by reference in its entirety.

### BACKGROUND OF THE INVENTION

1. Field of the Invention

The present invention relates to a display apparatus and, more particularly, to a display apparatus having improved display quality and a method of driving the display apparatus.

2. Description of the Related Art

In general, while a cathode ray tube display apparatus displays an image signal using an impulsive driving method, a liquid crystal display displays an image signal using a hold driving method. Thus, when the liquid crystal display displays a moving image, a blurring phenomenon (image tailing) occurs. In order to prevent the blurring of a moving image, a conventional liquid crystal display applies a black data signal to pixels during a black period within one frame after image data is applied to the pixels.

However, applying a black data signal degrades the brightness of the moving image. Further, the conventional liquid crystal display employs a gray-scale impulsive driving method that applies a gray-scale that is comparatively lower than that of the image data during the black period in order to prevent brightness degradation. The gray-scale impulsive driving method determines the gray-scale of the black period of the present frame from a consideration of the gray-scale information of a previous frame.

In order to enhance the viewing angle of the liquid crystal display to which the impulsive driving method is applied, a driving method is sometimes employed that divides a frame into two sub-frames and displays an image having a higher gray-scale than that of the original image during an earlier sub frame and displays an image having a lower gray-scale than that of the original image data during a later sub frame. While the above-described driving method improves viewing angle, it suffers from flicker.

### SUMMARY OF THE INVENTION

The present invention, according to one aspect thereof, provides a display apparatus having improved viewing angle that does not suffer from flicker and which also provides a suitable method for driving the display apparatus.

In one aspect of the present invention, a display apparatus includes a timing controller, a gamma voltage generator, a data driver, a gate driver, and a display panel. The timing controller receives image data corresponding to a frame and an external control signal, converts the external control signal into a first control signal and a second control signal, and outputs the image data in synchronization with the first control signal. The gamma voltage generator outputs a first gamma reference voltage and a second gamma reference voltage having a voltage level different from the first gamma reference voltage.

The data driver receives the first control signal and the image data from the timing controller and converts a first group of the image data into a first data voltage based on the first gamma reference voltage during a first period of the frame and converts a second group of the image data into a second data voltage based on the second gamma reference voltage during the first period. The data driver converts the first group into the second image voltage based on the second gamma reference voltage during a second period of the frame and converts the second group into the first data voltage based on the first gamma reference voltage during the second period of the frame.

The gate driver sequentially outputs a gate signal in response to the second control signal during the frame. The gate signal includes a first gate pulse corresponding to the first period and a second gate pulse corresponding to the second period.

The display panel includes a first pixel group and a second pixel group. The first pixel group receives the first data voltage in response to the first gate pulse to display a first gray-scale image having a different gray-scale from the image data during the first period, and receives the second data voltage in response to the second gate pulse to display a second gray-scale image having a different gray-scale from the image data during the second period. The second pixel group receives the second data voltage in response to the first gate pulse to display the second gray-scale image during the first period, and receives the first data voltage in response to the second gate pulse to display the first gray-scale image during the second period.

According to another aspect of the present invention, a method of driving a display apparatus comprises inputting the image data and an external control signal corresponding to one frame, converting the external control signal into a first control signal and a second control signal and outputting the image data in synchronization with the first control signal. A first gamma reference voltage and a second gamma reference voltage having a voltage level different from the first gamma reference voltage are output. A first group of the image data is converted into a first data voltage based on the first gamma reference voltage during a first period of the frame, and a second group of the image data is converted into a second data voltage based on the second gamma reference voltage during the first period. Next, the first group is converted into the second image voltage based on the second gamma reference voltage during a second period of the frame, and the second group is converted into the first data voltage based on the first gamma reference voltage during the second period of the frame. A gate signal is sequentially output in response to the second control signal during the one frame, and the gate signal includes a first gate pulse corresponding to the first period and a second gate pulse corresponding to the second period. When the first data voltage is received in response to the first gate pulse, a first gray-scale image having a different gray-scale from the image data is displayed on a first pixel region during the first period. When the second data voltage is received in response to the first gate pulse, a second gray-scale image having a different gray-scale from the image data and the first gray-scale image is displayed on a second pixel region during the first period. Then, when the second data voltage is received in response to the second gate pulse, the second gray-scale image is displayed on the first pixel region during the second period, and when the first data voltage is received in response to the second gate pulse, the first gray-scale image is displayed on the second pixel region during the second period.

According to the above, the high gray-scale image and the low gray-scale image are alternately displayed in at least one pixel during the first sub frame. The pixel that displays the high gray-scale image during the first sub frame displays the low gray-scale image during the second sub frame, and the pixel that displays the low gray-scale image during the first sub frame displays the high gray-scale image during the second sub frame. Thus, the viewing angle characteristic of the display apparatus is preserved and flicker is prevented.

A liquid crystal display capable of displaying moving images without flicker, comprising first and second pixel groups, and a data driver for converting image data for a frame into two groups of data voltages based on respective gamma reference voltages during respective periods of the frame, the first and second pixel groups receiving the first and second data voltages to display first and second gray-scale images, respectively, during the first period, and receiving the second and first data voltages to display the second and first gray-scale images, respectively, during the second period.

### BRIEF DESCRIPTION OF THE DRAWINGS

The above and other advantages of the present invention will become readily apparent by reference to the following detailed description when considered in conjunction with the accompanying drawings, in which:

FIG. 1 is a block diagram showing an exemplary embodiment of a liquid crystal display according to the present invention;

FIG. 2A is a view showing a gray-scale in each pixel during a first sub frame of the display panel of FIG. 1;

FIG. 2B is a view showing a gray-scale in each pixel during a second sub frame of the display panel of FIG. 1;

FIG. 3 is a waveforms diagram showing a data voltage applied to the first and second pixels of FIGS. 2A and 2B;

FIG. 4A is a view showing a gray-scale in each pixel during a first sub frame of a display panel according to another exemplary embodiment of the present invention;

FIG. 4B is a view showing a gray-scale in each pixel during a second sub frame of the display panel according to another exemplary embodiment of the present invention;

FIG. 5 is a waveforms diagram showing a data voltage applied to the first and second pixels of FIGS. 4A and 4B; and

FIG. 6 is a waveforms diagram showing a gray-scale variation of a data voltage in accordance with the gate signal.

### DESCRIPTION OF THE EMBODIMENTS

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

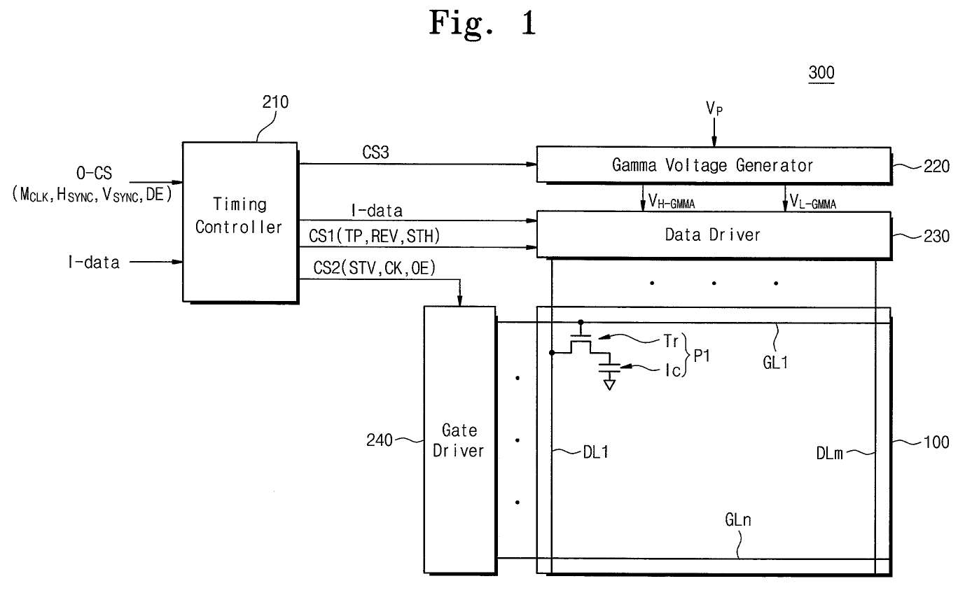

FIG. 1 is a block diagram showing an exemplary embodiment of a liquid crystal display according to the present invention.

Referring to FIG. 1, a liquid crystal display 300 includes a display panel 100, a timing controller 210, a gamma voltage generator 220, a data driver 230, and a gate driver 240.

The display panel 100 includes first to m-th data lines DL1˜DLm, first to n-th gate lines GL1˜GLn, and (n×m) pixels. The first to m-th data lines DL1˜DLm are insulated from and intersected with the first to n-th gate lines GL1˜GLn to define (n×m) pixel regions arranged in a matrix configuration. The (n×m) pixels are arranged in a one-to-one correspondence relationship to the (n×m) pixel regions.

Each of the (n×m) pixels includes a thin film transistor Tr and a liquid crystal capacitor Ic electrically connected to an output electrode of the thin film transistor Tr. Although not shown in FIG. 1, each of the (n×m) pixels may further include a storage capacitor connected to the liquid crystal capacitor Ic in parallel.

As an example of the present exemplary embodiment, in a first pixel P1 among the (n×m) pixels, the thin film transistor Tr includes a control electrode connected to a first gate line GL1, an input electrode connected to a first data line DL1, and an output electrode connected to the liquid crystal capacitor Ic.

The timing controller 210 receives an external control signal O-CS and an image data I-data. In the present exemplary embodiment, the external control signal O-CS includes a vertical synchronization signal VSYNC, a horizontal synchronization signal HSYNC, a main clock MCLK and a data enable signal DE. The timing controller 210 generates a data control signal CS1, a gate control signal CS2 and a gamma control signal CS3 based on the external control signal O-CS.

The timing controller 210 sequentially applies the image data I-data to the data driver 230 in synchronization with the data control signal CS1. In the present exemplary embodiment, the data control signal CS1 includes a horizontal start signal STH that starts an operation of the data driver 230, a reverse signal REV that reverses a polarity of a data voltage, and an output indication signal TP that indicates an output timing of the data voltage from the data driver 230. The timing controller 210 applies the gate control signal CS2 to the gate driver 240. In the present exemplary embodiment, the gate control signal CS2 includes a vertical start signal that starts an operation of the gate driver 240, a gate clock signal CK that indicates an output timing of the gate signal, and an output enable signal OE that determines a pulse width of the gate signal.

As an example of the present embodiment, the gate clock signal CK has a frequency of about 120 Hz. Assuming that one frame of the liquid crystal display 300 corresponds to 1/60 seconds, the one frame is divided into first and second frames each which correspond to 1/120 seconds. The first sub frame is defined as an earlier ½ frame, and the second sub frame is defined as a later ½ frame. Each of the pixels displays images having different gray-scale during the first and second frames.

Also, the timing controller 210 applies the gamma control signal CS3 to the gamma voltage generator 220. The gamma voltage generator 220 outputs a high gamma reference voltage V_{H-GMMA} and a low gamma reference voltage V_{L-GMMA} in response to the gamma control signal CS3. Although not shown in FIG. 1, the gamma voltage generator 220 includes a first gamma string that generates the high gamma reference voltage V_{H-GMMA} and a second gamma string that generates the low gamma reference voltage V_{L-GMMA}.

The high gamma reference voltage V_{H-GMMA} may be a positive high gamma reference voltage or a negative high gamma reference voltage in accordance with the reverse signal REV applied to the data driver 230. Similar to the high gamma reference voltage V_{H-GMMA}, the low gamma reference voltage V_{L-GMMA} may be a positive low gamma reference voltage or a negative low gamma reference voltage in accordance with the reverse signal REV.

In the present exemplary embodiment, the liquid crystal display 300 is operated in a line inversion method of which the polarity of the data voltage is inverted at every row, so that polarities of the high and low gamma reference voltages V_{H-GMMA} and V_{L-GMMA} are inverted at every horizontal scanning period (hereinafter, referred to as H/2 period).

The data driver 230 converts the image data I-data provided from the timing controller 210 into the data voltage based on the high and low gamma reference voltages V_{H-GMMA} and V_{L-GMMA}. In particular, the image data applied to odd-numbered pixels of a first pixel row during the earlier ½ horizontal scanning period is converted into a high data voltage having a high gray-scale based on the high gamma reference voltage V_{H-GMMA}, and the image data applied to even-numbered pixels of the first pixel row during the ½ horizontal scanning period is converted into a low data voltage having a low gray-scale based on the low gamma reference voltage V_{L-GMMA}. The image data applied to the odd-numbered pixels of the first pixel row during a later ½ horizontal scanning period is converted into the low data voltage having the low gray-scale based on the low gamma reference voltage V_{L-GMMA}, and the image data applied to the even-numbered pixels of the first pixel row during the later ½ horizontal scanning period is converted into the high data voltage having the high gray-scale based on the high gamma reference voltage V_{H-GMMA}.

The data driver 230 is electrically connected to the first to m-th data lines DL1˜DLm arranged on the display panel 100. During the earlier ½ horizontal scanning period of the first pixel row, the data driver 230 applies the high data voltage to odd-numbered data lines among the first to m-th data lines DL1˜DLm and applies and the low data voltage to even-numbered data lines among the first to m-th data lines DL1˜DLm. Then, during the later ½ horizontal scanning period of the first pixel row, the data driver 230 applies the low data voltage to the odd-numbered data lines and applies the high data voltage to the even-numbered data lines.

The gate driver 240 sequentially outputs a gate signal that swings between a gate-on voltage and a gate-off voltage in response to the gate control signal CS1 from the timing controller 210. The gate driver 240 is electrically connected to the first to n-th gate lines GL1˜GLn arranged on the display panel 100, and the gate signal is sequentially applied to the first to n-th gate lines GL1˜GLn. Thus, the display panel 100 may display images having gray-scales corresponding to the high and low data voltages in response to the gate signal.

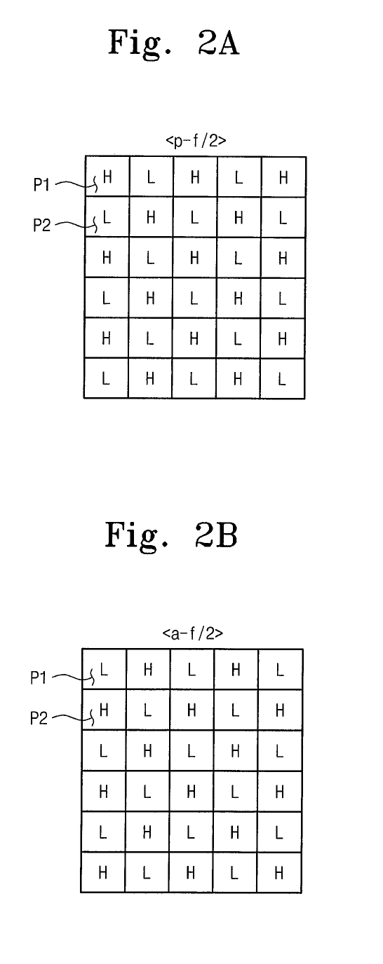

FIG. 2A is a view showing a gray-scale in each pixel during a first sub frame of the display panel of FIG. 1, and FIG. 2B is a view showing a gray-scale in each pixel during a second sub frame of the display panel of FIG. 1.

Referring to FIG. 2A, the high data voltage is applied to the odd-numbered in odd-numbered rows during a first sub frame p-f/2, and the low data voltage is applied to the even-numbered pixels in the odd-numbered rows during the first sub frame p-f/2. Also, the low data voltage is applied to the odd-numbered pixels in the even-numbered rows during the first sub frame p-f/2, and the high data voltage is applied to the even-numbered pixels in the even-numbered rows during the first sub frame p-f/2. As a result, the high and low data voltages are alternately applied to each pixel during the first sub frame p-f/2. Thus, a high gray-scale image H and a low gray-scale image L are displayed together with each other during the first sub frame p-f/2.

As shown in FIG. 2, the low data voltage is applied to the odd-numbered pixels in the odd-numbered rows during a second sub frame a-f/2, and the high data voltage is applied to the even-numbered pixels in the odd-numbered rows during the second sub frame a-f/2. Also, the high data voltage is applied to the odd-numbered pixels in the even-numbered rows during the second sub frame a-f/2, and the low data voltage is applied to the even-numbered pixels in the even-numbered rows during the second sub frame a-f/2. As a result, the high and low data voltages are alternately applied to each pixel during the second sub frame a-f/2. Thus, the high gray-scale image H and the low gray-scale image L are displayed together with each other during the second sub frame a-f/2.

Also, a pixel to which the high data voltage is applied during the first sub frame p-f/2 receives the low data voltage during the second sub frame a-f/2, and a pixel to which the low data voltage is applied during the first sub frame p-f/2 receives the high data voltage during the second sub frame a-f/2. Therefore, each pixel may alternately display the high gray-scale image H and the low gray image L in every sub frame.

In FIGS. 2A and 2B, a structure that the high and low data voltages are alternately applied to each pixel has been described. However, the high and low data voltages may be alternately applied to the pixels in every two pixels.

As above-described, two data voltages having different voltage level from each other are applied to each pixel in every ½ frame, so that the viewing angle characteristic may be improved and the display quality of the moving image may be improved. Further, the high gray-scale image H and the low gray-scale image L are displayed together with each other, thereby preventing flicker.

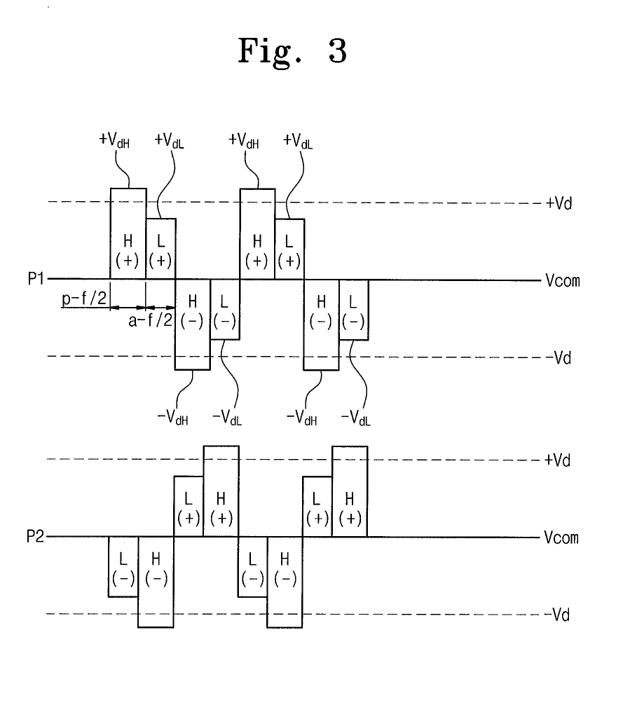

FIG. 3 is a waveforms diagram showing the data voltages applied to the first and second pixels of FIGS. 2A and 2B.

Referring to FIG. 3, a positive-polarity high data voltage +V_{dH} having a gray-scale higher than that of a positive-polarity data voltage +V_{d} corresponding to the image data is applied to a first pixel P1 during the first sub frame p-f/2, and a positive-polarity low data voltage +V_{dL} having a gray-scale lower than that of the positive-polarity data voltage +V_{d} is applied to the first pixel P1 during the second sub frame a-f/2.

A negative-polarity high data voltage −V_{dH} having a gray-scale higher than that of a negative-polarity data voltage −V_{d} is applied to the first pixel P1 during the first sub frame p-f/2 of a next frame, and a negative-polarity low data voltage −V_{dL} having a gray-scale lower than that of the negative-polarity data voltage −V_{d} is applied to the first pixel P1 during the second sub frame a-f/2 of the next frame.

The negative-polarity low data voltage −V_{dL} having the gray-scale lower than that of the negative-polarity data voltage −V_{d} corresponding to the image data is applied to the second pixel P2 during the first sub frame p-f/2, and the negative-polarity high data voltage −V_{dH} having the gray-scale higher than that of the negative-polarity data voltage −V_{d} is applied to the second pixel P2 during the second sub frame a-f/2.

The positive-polarity low data voltage +V_{dL} having the gray-scale lower than that of the positive-polarity data voltage +V_{d} is applied to the second pixel P2 during the first sub frame p-f/2 of the next frame, and the positive-polarity high data voltage +V_{dH} having the gray-scale higher than that of the positive-polarity data voltage +V_{d} is applied to the second pixel P2 during the second sub frame a-f/2 of the next frame. That is, the polarity of the data voltage is inverted in every frame and the gray-scale of the data voltage is changed in every ½ frame. Also, the polarity of the data voltage is inverted in every pixel row and the gray-scale of the data voltage is changed in every pixel row.

As described above, the high gray-scale image H and the low gray-scale image L are together with each other in every one pixel and displayed in a time interval of the ½ frame, thereby improving the viewing angle characteristic and preventing flicker.

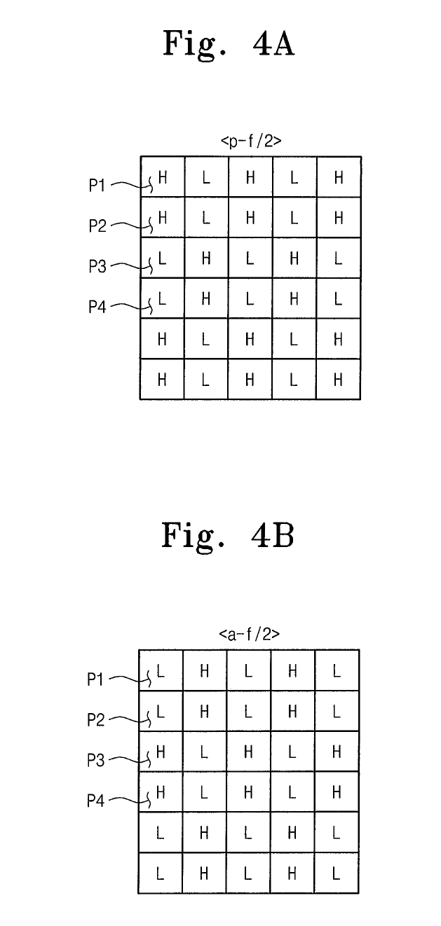

FIG. 4A is a view showing a gray-scale in each pixel during a first sub frame of a display panel according to another exemplary embodiment of the present invention, and FIG. 4B is a view showing a gray-scale in each pixel during a second sub frame of the display panel according to another exemplary embodiment of the present invention.

Referring to FIGS. 4A and 4B, the gray-scale of the data voltage is changed in every two pixel rows and in every pixel column during the first and second sub frames p-f/2 and a-f/2. As a result, the high and low data voltages are alternately applied to every (2×1) pixels of the pixels during the first and second sub frames p-f/2 and a-f/2. Accordingly, the high gray-scale image H and the low gray-scale image L are displayed together with each other during the first sub frame p-f/2.

Further, the gray-scale of the data voltage is changed in every ½ frame. More specifically, a pixel to which the high data voltage having the high gray-scale is applied during the first sub frame p-f/2 receives the low data voltage having the low gray-scale during the second sub frame a-f/2. A pixel to which the low data voltage having the low gray-scale is applied during the first sub frame p-f/2 receives the high data voltage having the high gray-scale during the second sub frame a-f/2.

As the above-described, the two data voltages having different voltage level from each other are applied to each pixel in every ½ frame, so that the viewing angle characteristic and the display quality of the moving image are improved by the impulsive effect. Further, the high gray-scale image H and the low gray-scale image L are displayed together with each other, thereby preventing the flicker.

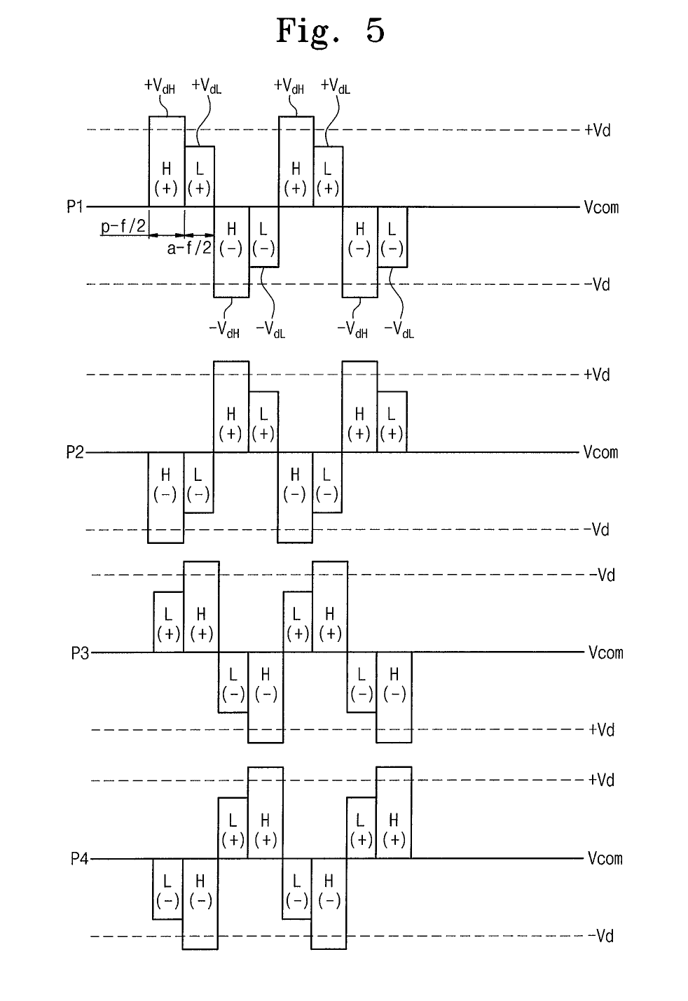

FIG. 5 is a waveforms diagram showing the data voltages applied to the first and second pixels of FIGS. 4A and 4B.

Referring to FIG. 5, a positive-polarity high data voltage +V_{dH} having a gray-scale higher than that of a positive-polarity data voltage +V_{d} corresponding to the image data is applied to a first pixel P1 during the first sub frame p-f/2, and a positive-polarity low data voltage +V_{dL} having a gray-scale lower than that of the positive-polarity data voltage +V_{d} is applied to the first pixel P1 during the second sub frame a-f/2.

A negative-polarity high data voltage −V_{dH} having a gray-scale higher than that of a negative-polarity data voltage −V_{d} is applied to the second pixel P2 during the first sub frame p-f/2, and a negative-polarity low data voltage −V_{dL} having a gray-scale lower than that of the negative-polarity data voltage −V_{d} is applied to the second pixel P2 during the second sub frame a-f/2.

The positive-polarity low data voltage +V_{dL} having the gray-scale lower than that of the positive-polarity data voltage +V_{d} is applied to the third pixel P3 during the first sub frame p-f/2, and the positive-polarity high data voltage +V_{dH} having the gray-scale higher than that of the positive-polarity data voltage +V_{d} is applied to the third pixel P3 during the second sub frame a-f/2.

The negative-polarity low data voltage −V_{dL} having the gray-scale lower than that of the negative-polarity data voltage −V_{d} corresponding to the image data is applied to the fourth pixel P4 during the first sub frame p-f/2, and the negative-polarity high data voltage −V_{dH} having the gray-scale higher than that of the negative-polarity data voltage −V_{d} is applied to the fourth pixel P4 during the second sub frame a-f/2.

As shown in FIG. 5, the polarity of the data voltage is inverted in every frame. Also, the gray-scale of the data voltage is changed in every ½ frame and in every two pixel rows, so that the viewing angle characteristic is improved and flicker is prevented.

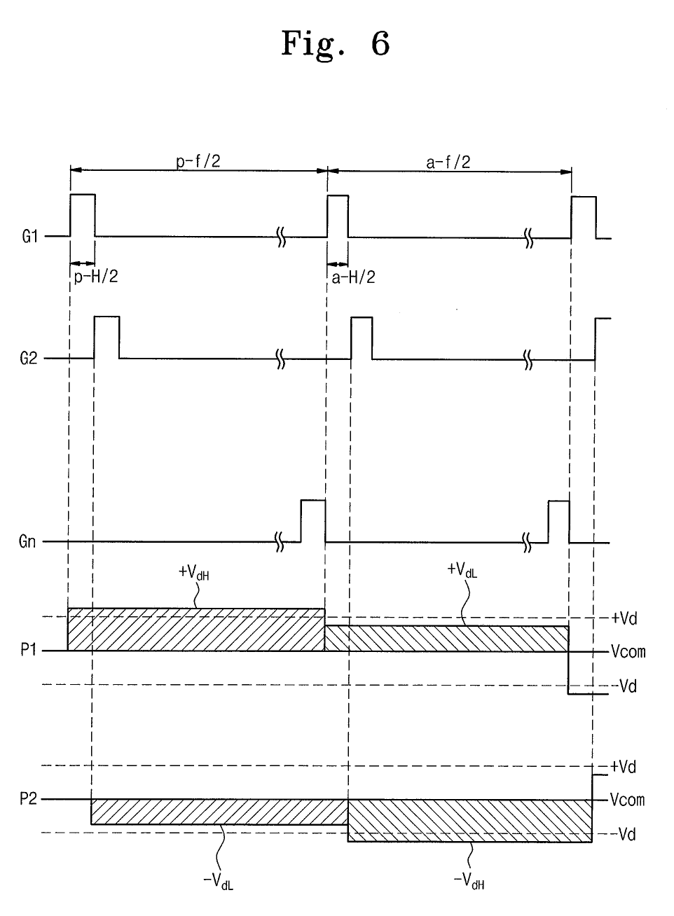

FIG. 6 is a waveforms diagram showing a gray-scale variation of the data voltage in accordance with the gate signal.

Referring to FIG. 6, the gate driver 240 (shown in FIG. 1) sequentially outputs first to n-th gate signals GS1˜GSn to the first to n-th gate lines GL1˜GLn arranged on the display panel 100. Each of the first to n-th gate signals GS1˜GSn includes a first gate pulse output as the gate-on voltage during an H/2 period p-H/2 within the first sub frame p-f/2 and a second gate pulse output as the gate-on voltage during the H/2 period a-H/2 within the second sub frame a-f/2.

The data driver 230 (shown in FIG. 1) applies the data voltage to the first to m-th data lines DL1˜DLm arranged on the display panel 100 during the H/2 period p-H/2 within the first sub frame p-f/2 of the first to n-th gate signals GS1˜GSn.

More specifically, the positive-polarity high data voltage +V_{dH} is applied to the first pixel P1 (shown in FIGS. 2A and 2B) during the first sub frame p-f/2 in response to the first gate pulse of the first gate signal GS1, and the negative-polarity low data voltage −V_{dL} is applied to the second pixel P2 during the first sub frame p-f/2 in response to a first gate pulse of the second gate signal GS2.

The positive-polarity low data voltage +V_{dL} is applied to the first pixel P1 during the second sub frame a-f/2 in response to the second gate pulse of the first gate signal GS1, and the negative-polarity high data voltage −V_{dH} is applied to the second pixel P2 in response to the second gate pulse of the second gate signal GS2.

As described above, each of the first to n-th gate signals GS1˜GSn includes the first and second gate pulses output as the gate-on voltage, thereby controlling timing where the high and low data voltages are alternately applied to each pixel within the same frame.

According to the display apparatus and the driving method for the display apparatus, the high gray-scale image and the low gray-scale image are alternately applied to at least one pixel during the first sub frame. The pixel that displays the high gray-scale image during the first sub frame displays the low gray-scale image during the second sub frame, and the pixel that displays the low gray-scale image during the first sub frame displays the high gray-scale image during the second sub frame.

Thus, images having different gray-scale from each other are displayed in every first and second sub frames, thereby improving the viewing angle characteristic of the display apparatus and the display quality of a moving image. Further, since the high gray-scale image and the low gray-scale image are displayed together with each other during the first and second sub frames, flicker is prevented.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a timing controller for receiving image data and an external control signal corresponding to a frame and converting the external control signal into a first control signal and a second control signal, and outputting the image data in synchronization with the first control signal;
a gamma voltage generator for outputting a gamma reference voltage;
a data driver for receiving the first control signal and the image data and converting a first group of the image data into a first data voltage during a first period of the frame, converting a second group of the image data into a second data voltage during the first period, converting the first group into the second image voltage during a second period of the one frame and converting the second group into the first data voltage during the second period of the frame;
a gate driver for sequentially outputting a gate signal in response to the second control signal during the frame, the gate signal having a first gate pulse corresponding to the first period and a second gate pulse corresponding to the second period; and
a display panel comprising:
a first pixel group receiving the first data voltage in response to the first gate pulse to display a first gray-scale image having a different gray-scale from the image data during the first period, and receiving the second data voltage in response to the second gate pulse to display a second gray-scale image having a different gray-scale from the image data during the second period; and
a second pixel group receiving the second data voltage in response to the first gate pulse to display the second gray-scale image during the first period, and receiving the first data voltage in response to the second gate pulse to display the first gray-scale image during the second period.

2. The display apparatus of claim 1, further comprising a gamma voltage generator for outputting a gamma reference voltage and a second gamma reference voltage having a voltage level different from the first gamma reference voltage.

3. The display apparatus of claim 2, wherein the first group of the image data is converted into the first data voltage based on the first gamma reference voltage during the first period and converted into the second data voltage based on the second gamma reference voltage during the second period, the second group of the image data is converted into the second data voltage based on the second gamma reference voltage during the first period and converted into the first data voltage based on the first gamma reference voltage during the second period.

4. The display apparatus of claim 2, wherein the first gamma reference voltage is higher than the second gamma reference voltage, the gray-scale of the first gray-scale image is higher than the image data, and the gray-scale of the second gray-scale image is lower than the image data.

5. The display apparatus of claim 2, wherein the first gamma reference voltage is lower than the second gamma reference voltage, the gray-scale of the first gray-scale image is lower than the image data, and the gray-scale of the second gray-scale image is higher than the image data.

6. The display apparatus of claim 1, wherein the first period indicates an earlier H/2 frame of the one frame, and the second period indicates a later H/2 frame of the one frame.

7. The display apparatus of claim 6, wherein each of the first and second periods is about 1/120 seconds.

8. The display apparatus of claim 1, wherein the first and second data voltages are inverted in every frame.

9. The display apparatus of claim 1, wherein the display panel comprises a plurality of pixels arranged in a matrix configuration, first pixels of the first pixel group and second pixels of the second pixel group are alternately and repeatedly arranged in at least one pixel.

10. The display apparatus of claim 1, wherein the display panel comprises a plurality of pixels arranged in a matrix configuration, first pixels of the first pixel group and second pixels of the second pixel group are alternately and repeatedly arranged in at least one row or in at least on column.

11. A method of driving a display apparatus, comprising:
receiving an image data corresponding to one frame and an external control signal and converting the external control signal into a first control signal and a second control signal to output the image data in synchronization with the first control signal;
converting a first group of the image data into a first data voltage during a first period of the one frame and converting a second group of the image data into a second data voltage during the first period;
converting the first group into the second image voltage during a second period of the one frame and converting the second group into the first data voltage during the second period of the one frame;
sequentially outputting a gate signal in response to the second control signal during the one frame, the gate signal having a first gate pulse corresponding to the first period and a second gate pulse corresponding to the second period; and
receiving the first data voltage in response to the first gate pulse to display a first gray-scale image having a different gray-scale from the image data on a first pixel region during the first period, and receiving the second data voltage in response to the first gate pulse to display a second gray-scale image having a different gray-scale from the image data and the first gray-scale image on a second pixel region during the first period; and
receiving the second data voltage in response to the second gate pulse to display the second gray-scale image on the first pixel region during the second period, and
receiving the first data voltage in response to the second gate pulse to display the first gray-scale image on the second pixel region during the second period.

12. The method of claim 11, further comprising outputting a first gamma reference voltage and a second gamma reference voltage having a voltage level different from the first gamma reference voltage.

13. The method of claim 12, wherein the first group of the image data is converted into the first data voltage based on the first gamma reference voltage during the first period and converted into the second data voltage based on the second gamma reference voltage during the second period, the second group of the image data is converted into the second data voltage based on the second gamma reference voltage during the first period and converted into the first data voltage based on the first gamma reference voltage during the second period.

14. The method of claim 12, wherein the first gamma reference voltage is higher than the second gamma reference voltage, the first gray-scale image having a gray-scale higher than the image data, and the second gray-scale image having a gray-scale lower than the image data.

15. The method of claim 12, wherein the first gamma reference voltage is lower than the second gamma reference voltage, the first gray-scale image having a gray-scale lower than the image data, and the second gray-scale image having a gray-scale higher than the image data.

16. The method of claim 11, wherein the first period indicates an earlier H/2 frame of the one frame, and the second period indicates a later H/2 frame of the one frame.

17. The method of claim 16, wherein the first and second data voltages are inverted in every frame.

18. A display apparatus comprising:
first and second pixel groups, and
a data driver for converting image data for a frame into two groups of data voltages based on respective gamma reference voltages during respective periods of the frame, the first and second pixel groups receiving the first and second data voltages to display first and second gray-scale images, respectively, during the first period, and receiving the second and first data voltages to display the second and first gray-scale images, respectively, during the second period.
